(19) United States
(12) Patent Application Publication
(10) Pub. No.: US 2006/0002393 A1
(43) Pub. Date: Jan. 5, 2006

(54) Primary control marker data structure

(75) Inventors: James B. Lappin JR., San Francisco, CA (US); Adote K. Messavussu, Hayward, CA (US)

Correspondence Address: DARBY & DARBY P.C., P.O. BOX 5257, NEW YORK, NY, 10150-6257, US

(73) Assignee: Nokia Inc., Irving, TX (US)

(21) Appl. No.: 10/882,418

(22) Filed: Jun. 30, 2004

(51) Int. Cl. H04L 12/56; H04L 12/28

(52) U.S. Cl. 370/392; 370/395.32; 370/401

(57) ABSTRACT

A data structure represented by a single 32 bit word or “primary control marker” that is inserted ahead of a header of a packet at the front of a flow of packets that is being processed by a network processor in a network device. The primary control marker includes the results of calculations that have been accelerated through the use of hardware (ASICs) to perform certain tasks in advance for the network processor. Because the insertion of in-band information has an impact on packet stream throughput, both the location of the insertion in the packet header and the type of results that are included in the primary control marker have an effect on the overall performance of the network processor, The data structure includes the results of IP header checksum verification, MAC level filtering and classification, VLAN indication, Flow Hash Index Calculation and Channel Identification.

### FIELD OF THE INVENTION

The invention is directed to interfaces for network devices, and more particularly, to a data structure that enables high speed communication with a network processor.

### BACKGROUND OF THE INVENTION

Over the last ten years, network devices have had to employ an ever increasing amount of resources to handle communication links with other nodes on a network and relatively complex communication protocols. To provide these additional resources, some network devices have significantly increased their memory and processing capacity (multi-processors, faster clock cycles, and the like). Other network devices have employed separate network processors to process most tasks associated with handling communication links and communication protocols. These network processors enable network devices to operate effectively in a large network with complex communication protocols without significantly increasing memory or processing capacity.

Although a network processor can help a network device achieve a higher level of performance, it is still a processor with instruction sets that are typically tailored toward applications associated with the processing of network traffic, and not the traffic itself. Also, if the number of packets to be processed by a network processor is too great, the network processor can become a bottleneck to greater performance. In the past, some tasks typically performed by the network processor have been implemented by specialized application specific integrated circuits (ASICs) in an attempt to alleviate some of the processing burden on the network processor with mixed results.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1A illustrates a block diagram of an exemplary network device that implements a GMII interface for enabling a network processor to communicate with I/O cards;

FIG. 1B shows a block diagram of another exemplary network device that employs a PL3 interface for enabling a network processor to communicate with I/O cards;

FIG. 2 illustrates a block diagram of an ASIC and the modules that perform tasks regarding received packets;

FIG. 3 shows a block diagram of the data structure for a primary control marker;

FIG. 4 illustrates a table regarding the coding of MAC level classification bits in a primary control marker; and

FIG. 5 shows a flow chart regarding the processing of the primary control marker, in accordance with the invention.

### DETAILED DESCRIPTION OF THE INVENTION

The present invention is now described. While it is disclosed in its preferred form, the specific embodiments of the invention as disclosed herein and illustrated in the drawings are not to be considered in a limiting sense. Rather, these embodiments are provided so that this disclosure will be thorough and complete, and will fully convey the scope of the invention to those skilled in the art. Indeed, it should be readily apparent in view of the present description that the invention may be modified in numerous ways. Among other things, the present invention may be embodied as devices, methods, software, and so on. Accordingly, the present invention may take the form of an entirely hardware embodiment, an entirely software embodiment or an embodiment combining software and hardware aspects. The following detailed description is, therefore, not to be taken in a limiting sense.

Briefly stated, the invention is directed to a data structure represented by a single 32 bit word or “primary control marker” that is inserted ahead of a header of a packet that is also positioned at the front of a flow of packets that is being processed by a network processor in a network device. The primary control marker includes the results of calculations that have been accelerated through the use of hardware such as (ASICs) to perform certain tasks on packets in advance of further processing by the network processor. Additionally, this pre-processing can be handled in firmware, or some combination of hardware and software that is relatively faster in providing a result than the network processor.

Because the insertion of in-band information has an impact on packet stream throughput, both the location of the insertion ahead of the packet header and the type of results that are included in the primary control marker have an effect on the overall performance of the network processor. The data structure of the primary control marker enables a 32 bit word to include the results of IP header checksum verification, MAC level filtering and classification, VLAN indication, Flow Hash Index Calculation and Channel Identification.

### Illustrative Operating Environment

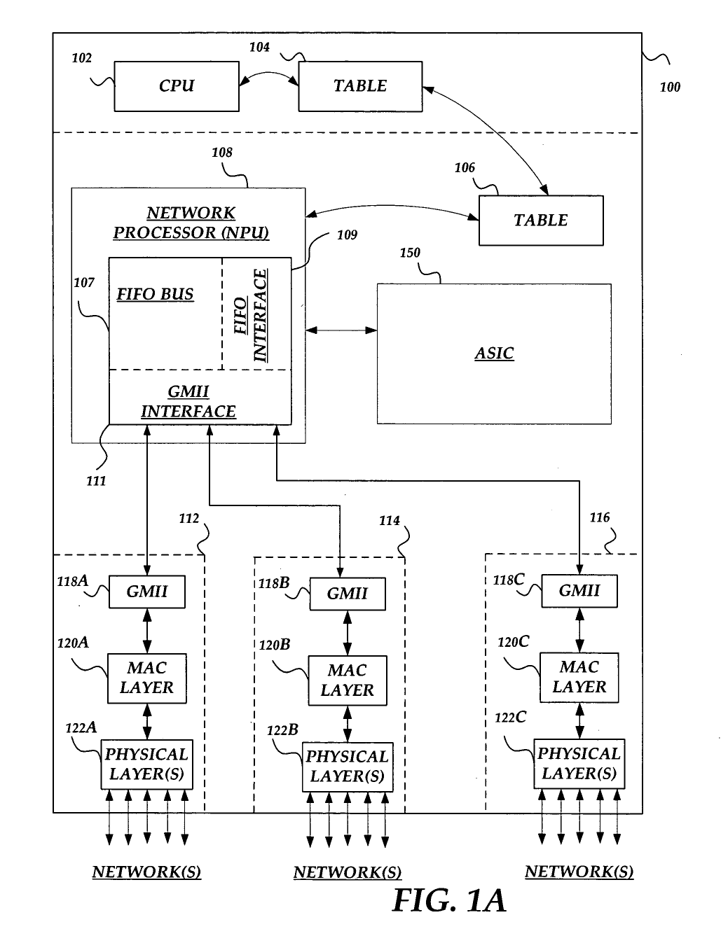

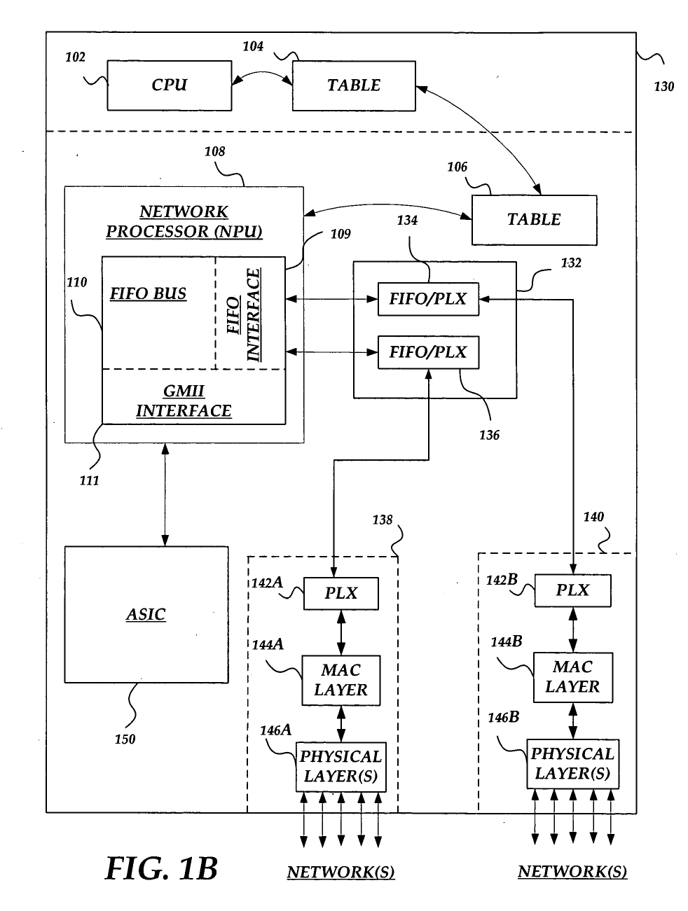

FIG. 1A illustrates a block diagram generally showing components included in network device 100 that are configured to employ the GMII interface to communicate over a network. The network device includes central processing unit (CPU) 102 and table 104 where the table includes a listing of information regarding communication links. Although other components for handling the general operation of the network device are not shown, they can also include Read Only Memory (ROM), Random Access Memory (RAM), power supply, flash memory, hard disk, pointing device interface, keyboard interface, software applications, and the like. In one embodiment, network processor 108 may be provided by the Broadcom corporation, such as part no. BCM 1250.

Network device 100 includes ASIC 150 and network processor (NPU) 108 which includes FIFO bus 110 for communicating over one of two interfaces with I/O cards 112, 114 and 116. GMII interface 111 converts the FIFO bus signals into GMII signals for communicating at substantially 1 gigabits per second with I/O cards 112, 114, and 116. Although not used in this embodiment, FIFO interface 109 is provided for converting the signals on the FIFO bus into a relatively “raw” data stream on the FIFO interface at a substantially higher rate than the GMII interface, e.g., 3.2 gigabits per second instead of 1.0 gigabits per second.

ASIC 150 is in communication with network processor 108 and the ASIC pre-processes several tasks that can alleviate the workload on the network processor. Tasks that ASIC 150 can perform include IP header checking, MAC level filtering and classification, VLAN indication, Flow Hash Index Calculation and Channel Identification. The results of these tasks are arranged in a data structure that corresponds to the primary control marker which is subsequently inserted ahead of a header into a packet at the front of a flow of packets. Additionally, this pre-processing can be handled in hardware, firmware, or some combination of hardware and software that is relatively faster in providing a result than the network processor.

Each of I/O cards 112, 114 and 1 16 include integrated components 118A, 118B, and 118C, respectively, for converting communication with GMII interface 111 into signals that can be handled at the MAC layer. Each of the I/O cards include respective components 120A, 120B, and 120C for processing MAC layer signals. Additionally, each of the I/O cards include components 122A, 122B, and 122C for processing physical layer signals (magnetics, electrical signals, and the like). In one embodiment, the I/O cards provide physical Ethernet interfaces to an internal network. In another embodiment, the I/O cards can provide other types of interfaces to internal and/or external networks. Also, the component for converting communication with the GMII interface into the MAC layer can be provided separately and not integrated with the I/O cards 112, 114, and 116.

FIG. 1B illustrates a block diagram generally showing components included in network device 130 that are configured to employ FIFO interface 109 to communicate over a network. Network device 130 is arranged in ways that are substantially similar to network device 100 as shown in FIG. 1A, albeit differently arranged in other ways.

FIFO interface 109 is in communication with bridge 132 which employs components 134 and 136 to convert/translate the signals from FIFO interface 109 (and clock speed) into other signals (and another clock speed) that are compliant with a bus that supports a PLX protocol, e.g., POS-Phy Level 3 (PL3), POS-Phy Level 4 (PL4), SPI 3, SPI 4, and the like.

Components 134 and 136 are coupled to and in communication with respective I/O cards 138 and 140. The FIFO interface provides a relatively “raw” data stream in a relatively proprietary FIFO format that bridge 132 is adapted to recognize. Bridge 132 bi-directionally provides translation/conversion between the relatively proprietary FIFO data stream and the relatively well known high speed PLX data signals.

Each of I/O cards 138 and 140, include integrated components 142A and 142B, respectively, for bi-directionally handling the communication of signals with bridge 132. These components also convert PLX signals into signals that can be handled at the MAC layer. Each of the I/O cards include respective components 144A, and 144B for processing MAC layer signals. Additionally, each of the I/O cards include components 146A and 146B for processing physical layer signals (magnetics, electrical signals, and the like). In one embodiment, the I/O cards provide physical Ethernet interfaces to an internal network. In another embodiment, the I/O cards can provide other types of interfaces to internal and/or external networks. Also, the component for handling PLX communication with bridge 132 can be provided separately and not integrated with the I/O card.

Typically, NPU 108 provides either three GMII ports for handling 3×2=6 Gigabits full duplex or two FIFO interfaces (16 bit, 200 MHz) providing a total 2×2×3.2=12.8 Gigabits full duplex. Bridge 132 can convert these two FIFO interfaces into two PLX interfaces, such as PL3, so that six GMII devices can be connected instead of three and thereby doubling connectivity.

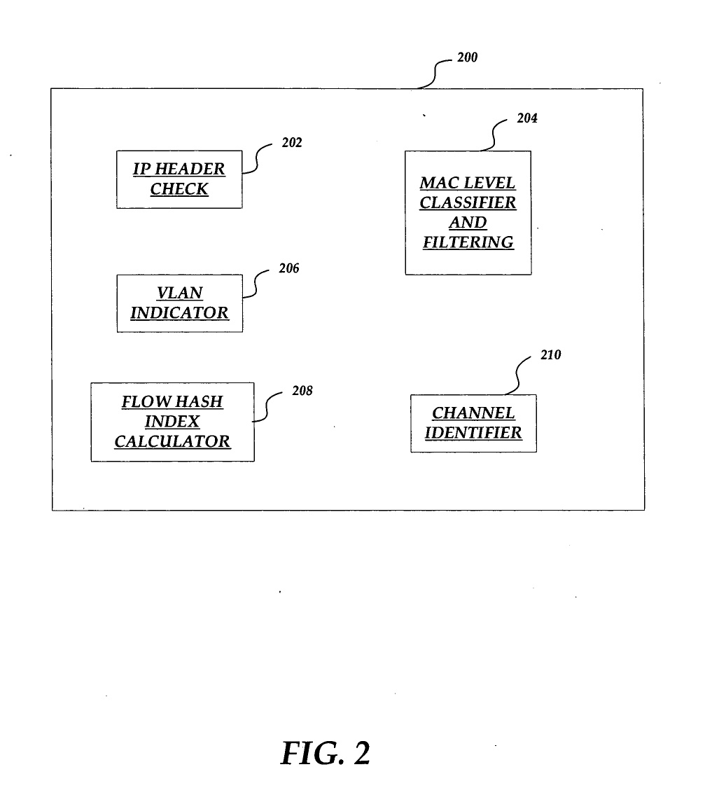

FIG. 2 illustrates a block diagram of an ASIC with modules for performing tasks in hardware, firmware, or some combination of hardware and software that is relatively faster in providing a result than the network processor. Module 202 performs the task of checking the header of an IP packet to indicate if IP header checksum has been recalculated and correctly matched to the value in the current packet header. Depending on the configuration parameters, the packet may or may not be dropped.

Module 204 performs the tasks of classifying and filtering a packet at the MAC layer of the OSI model. This module implements a destination address filtering scheme that can perform a variety of operations, including (a) send the packet to the network processor with no notification; (b) send the packet to the network processor with alert notification; or (c) drop the packet entirely.

Additionally, module 204 can classify the received flow of packets, including (a) all packets enabled—where every packet is sent to the network processor; (b) broadcast packets detected—and all of the packets are either dropped or warded to the network processor; (c) exact match—the received packet either exactly matches a specific address (unicast or multicast) and is forwarded to the network processor, or the received packet doesn't exactly match the specific address and it is dropped; and (d) hash match—a nine bit index that is derived from a hashing algorithm performed on the destination MAC address. This index value is employed as an address into a 512 entry by one bit table. If the corresponding data bit in the table is set, the packet is accepted and marked appropriately. However, if the data bit is not set in the table, the packet is either dropped or marked appropriately and forwarded to the network processor.

Module 206 performs the task of identifying whether or not a virtual LAN (VLAN) is associated with the flow of packets. Module 208 performs the tasks of performing and listing a flow hash index for the packet. Module 210 performs the tasks of determining and indicating which of 16 channels that the packet has been received on.

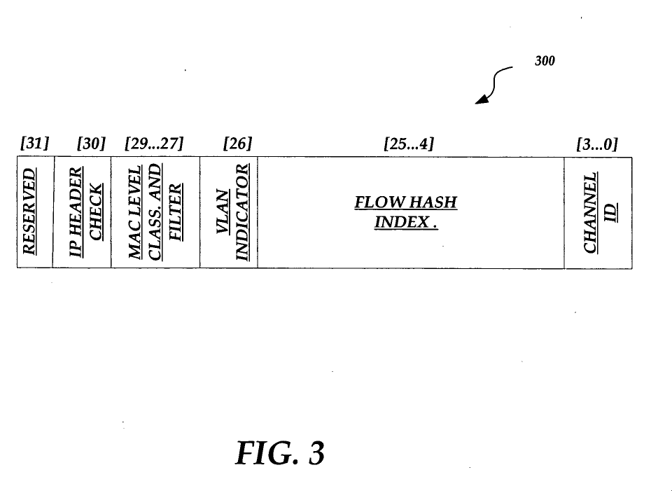

FIG. 3 illustrates the arrangement of the 32 bit word in the primary control marker's data structure with bits that are numbered zero through thirty one. As indicated, bits numbered zero through three are employed for channel identification. Bits numbered four through twenty-five are employed for a flow hash index value. The twenty-sixth bit is employed to indicate the presence of a VLAN in regard to the flow of received packets. Bits twenty-seven through twenty nine are employed to indicate MAC level classification and filtering. Bit thirty is used to indicate if the IP address checksum has been verified. Lastly, bit thirty-one is reserved for other operations. Additionally, since the primary control marker does not include a word type field, it is typically positioned as the first control marker which is inserted ahead of the header in the packet.

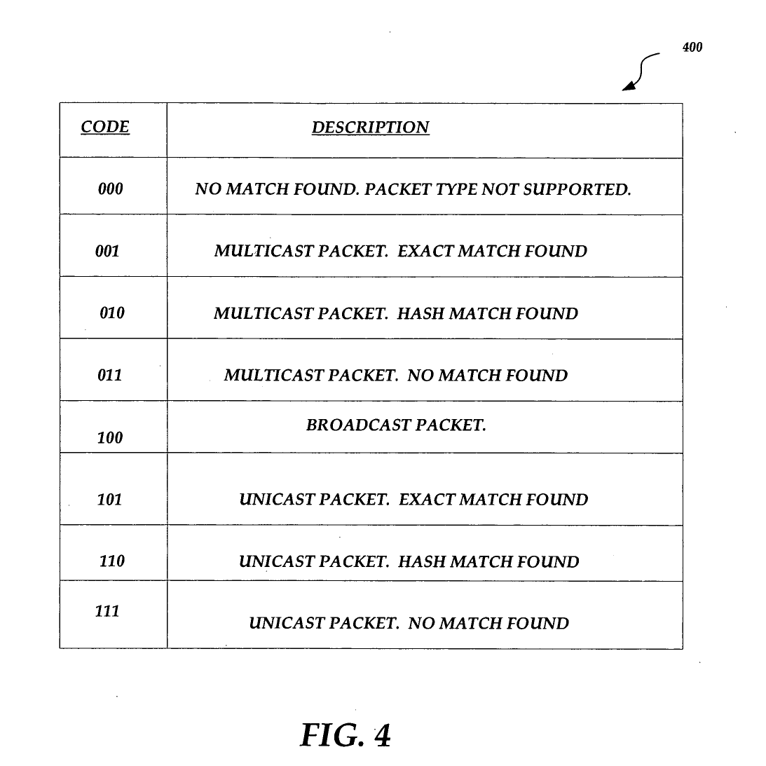

FIG. 4 illustrates a table that includes the code and description for MAC level classification and filtration for primary control marker bits twenty-seven through twenty-nine.

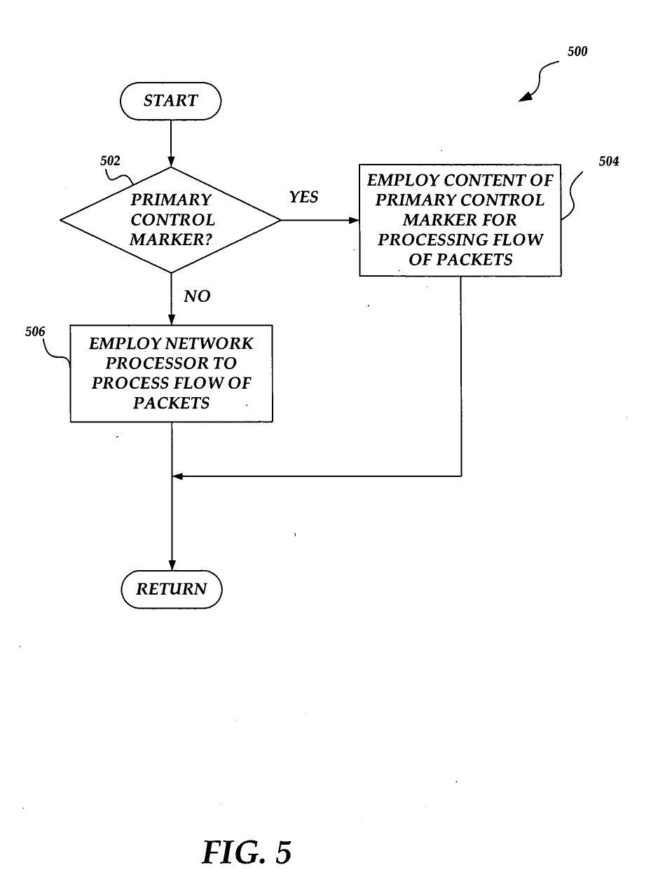

FIG. 5 shows a flow chart of process 500 for employing the content of the primary control market to reduce the processing burden on a network processor. Moving from a start block, the processor steps to decision block 502 where a determination is made as to whether a primary control marker is detected ahead of a header for a received packet. If true, the process moves to block 504 where a network processor employs the pre-processed results (content) in the primary control marker to process a flow of packets. Next, the process returns to performing other actions.

Alternatively, if the determination at decision block 502 is false, the process advances to block 506 where the network processor processes the flow of packets without relying upon the content of the primary control marker. However, although not shown, at least some of the pre-processed results included in the primary control marker, can be separately provided by modules that process the received packets in hardware, firmware, or some combination of hardware and software that is relatively faster in providing a result than the network processor.

Moreover, it will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. An apparatus for increasing the capacity of a network device, comprising:
a network processor; and
a component that performs actions, including:
pre-processing a plurality of tasks separate from a network processor for each received packet;
generating a word that includes a plurality of results for the pre-processed plurality of tasks;
inserting the word ahead of a header of a received packet, wherein the received packet is relatively near a front of a flow of received packets; and
providing the received packet with the inserted word to the network processor, wherein the network processor employs the results to process the flow of packets.

2. The apparatus of claim 1, wherein the network device is at least one of firewall, server, gateway, router, and a base station,

3. The apparatus of claim 1, wherein the plurality of results include at least one of IP header checksum verification, MAC level filtering and classification, VLAN indication, Flow Hash Index Calculation, and Channel Identification.

4. The apparatus of claim 1, wherein the component is an ASIC.

5. The apparatus of claim 1, wherein the word is thirty two bits long.

6. The apparatus of claim 1, wherein the word includes a one bit field that is reserved, and wherein the field is disposed at a thirty-second bit position in the word.

7. The apparatus of claim 1, wherein the word includes a one bit field that indicates the results of an IP header checksum, and wherein the field is disposed at a thirty-first bit position in the word.

8. The apparatus of claim 1, wherein the word includes a three bit field that indicates MAC level classification and filtration, and wherein the field is disposed between the thirtieth and the twenty-eight bit position in the word.

9. The apparatus of claim 1, wherein the word includes a one bit field that indicates the presence of a VLAN, and wherein the field is disposed at the twenty-seventh bit position in the word.

10. The apparatus of claim 1, wherein the word includes a twenty-two bit field for indicating a flow hash index associated with the received packet, and wherein the field is disposed between the twenty-sixth bit position and the fourth bit position in the word.

11. The apparatus of claim 1, wherein the word includes a three bit field that identifies a channel associated with the received packet, and wherein the field is disposed between the fourth bit position and the first bit position in the word.

12. A data structure for increasing the capacity of a network device, comprising:
a one bit field that is reserved, and which is disposed at a thirty-second bit position;
a one bit field that indicates the results of an IP header checksum, and which is disposed at a thirty-first bit position;
a three bit field that indicates MAC level classification and filtration, and which is disposed between the thirtieth and the twenty-eight bit position;
a one bit field that indicates the presence of a VLAN, and which is disposed at the twenty-seventh bit position;
a twenty-two bit field for indicating a flow hash index associated with the received packet, and which is disposed between the twenty-sixth bit position and the fourth bit position and
a three bit field that identifies a channel associated with the received packet and which is disposed between the fourth bit position and the first bit position, wherein the data structure is disposed ahead of a header of a packet that is also relatively near a front of a flow of packets.

13. The data structure of claim 12, further comprising a thirty-two bit word.

14. The data structure of claim 12, wherein the network device is at least one of firewall, server, gateway, router, and a base station,

15. The data structure of claim 12, wherein the fields include results from tasks that are pre-processed separate from a network processor.

16. The data structure of claim 12, wherein the fields are included in a thirty two bit word that is included ahead of the header in the packet that is relatively near the front of the flow of packets.

17. A method for increasing the capacity of a network device, comprising:
pre-processing a plurality of tasks separate from a network processor for each received packet;
generating a word that includes a plurality of results for the pre-processed plurality of tasks;
inserting the word ahead of a header of a received packet, wherein the received packet is relatively near a front of a flow of received packets; and
providing the received packet with the inserted word to the network processor, wherein the network processor employs the plurality of results to process the flow of packets.

18. The method of claim 17, wherein the word is thirty-two bit and the network device is at least one of firewall, server, gateway, router, and a base station,

19. The method of claim 17, wherein the plurality of results include at least one of IP header checksum verification, MAC level filtering and classification, VLAN indication, Flow Hash Index Calculation, and Channel Identification.

20. An apparatus for increasing the capacity of a network device, comprising:
means for pre-processing a plurality of tasks in hardware for each received packet;
means for generating a word that include a plurality of results for the plurality of tasks;
means for inserting the word ahead of a header of a received packet, wherein the received packet is relatively near a front of a flow of received packets; and
means for providing the received packet with the inserted word to a network processor, wherein the network processor employs the plurality of results to process the flow of packets.
